(19) United States
(12) Patent Application Publication
(10) Pub. No.: US 2026/0089811 A1
(43) Pub. Date: Mar. 26, 2026

(54) TEMPERATURE SENSOR ASSEMBLY FOR AN INDUCTION HOB

(71) Applicant: COPRECI, S.COOP., Aretxabaleta (ES)

(72) Inventors: Iker ELCARTE MIGUEZ, Pamplona (ES); Sergio GARCIA ZARZOSA, Elorrio (ES); Ion LOIDI EGUREN, Bergara (ES); Pablo Igor VICENTE ARANCETA, Elorrio (ES); Jesus GUTIERREZ IGLESIAS, Aretxabaleta (ES)

(21) Appl. No.: 19/323,293

(22) Filed: Sep. 9, 2025

(30) Foreign Application Priority Data
Sep. 25, 2024 (EP) 24383024.7

(51) Int. Cl. H05B 6/12

(52) U.S. Cl. CPC H05B 6/1209; H05B 2213/07

(57) ABSTRACT

Temperature sensor assembly for an induction hob. The temperature sensor assembly includes an axial thermistor and a support having a base on which the thermistor is horizontally arranged. The thermistor includes an elongated main body, a first pin projecting from a first end of the main body, and a second pin projecting from a second end of the main body. The first pin is connected to a first connecting cable forming a first connecting segment, and the second pin is connected to a second connection cable forming a second connecting segment. The first pin includes an initial bent segment and an additional segment following the initial bent segment which is arranged on the base of the support on one side of the main body of the thermistor and extends at least to the second end of the elongated main body in an axial direction defined by the elongated main body.

### CROSS-REFERENCE TO RELATED APPLICATIONS

This application relates to and claims the benefit and priority to European Application No. EP24383024.7, filed Sep. 25, 2024, which is incorporated by reference herein in its entirety.

### TECHNICAL FIELD

The present invention relates to temperature sensor assemblies for an induction hob.

### BACKGROUND

Temperature sensors are used in hobs to receive information about the current status of a hob element (e.g. a heating element) or an element with which the induction hob interacts (e.g. a pot or vessel), or to control the operation of the hob.

The temperature sensor is usually fixed to the hob by means of a support to ensure reliable temperature measurement. Different types of temperature sensors are commonly used.

EP3671043A1 discloses a temperature sensor assembly for an induction hob comprising an axial thermistor and a support comprising a base on which the thermistor is arranged. The axial thermistor comprises an elongated main body, a first pin projecting axially from a first end of the main body, and a second pin projecting axially from a second end of the main body, the main body of the thermistor being arranged horizontally on the base. The first pin is connected to a first connecting cable forming a first connecting segment and the second pin is connected to a second connecting cable forming a second connecting segment.

### SUMMARY

Disclosed is a temperature sensor assembly for an induction hob and an induction hob comprising at least an induction heater and said temperature sensor assembly.

The temperature sensor assembly of the invention comprises an axial thermistor and a support comprising a base on which the thermistor is arranged. The thermistor comprises an elongated main body, a first pin projecting axially from a first end of the main body, and a second pin projecting axially from a second end of the main body.

The main body of the thermistor is arranged horizontally on the base. The first pin is connected to a first connecting cable forming a first connecting segment, and the second pin is connected to a second connecting cable forming a second connecting segment.

The first pin of the thermistor comprises an initial bent segment and an additional segment following the initial segment which is arranged on the base of the support on one side of the main body of the thermistor and extends at least to the second end of the main body in an axial direction defined by the main body. By bending the first pin in this way, the accuracy of the temperature measurement is considerably improved, since the effect produced by the electromagnetic fields generated at the induction heater is minimised. This makes it possible to use axial thermistors instead of more expensive sensors, such as ceramic sensors for example, since a sufficiently good temperature measurement is obtained.

These and other advantages and features will become apparent in view of the figures and the detailed description.

### BRIEF DESCRIPTION OF THE DRAWINGS

FIG. 1 shows a simplified partial schematic view of an embodiment of the invention.

FIG. 2 shows a perspective view of an embodiment of the invention.

FIG. 3 shows a plan view of the embodiment of FIG. 2.

FIG. 4 shows a section view of the embodiment of FIG. 2.

FIG. 5 shows a perspective view of an induction heater of an induction hob comprising the temperature sensor assembly of FIG. 2.

FIG. 6 shows a section view of the induction heater of FIG. 5 with the addition of a cooking plate.

### DETAILED DESCRIPTION

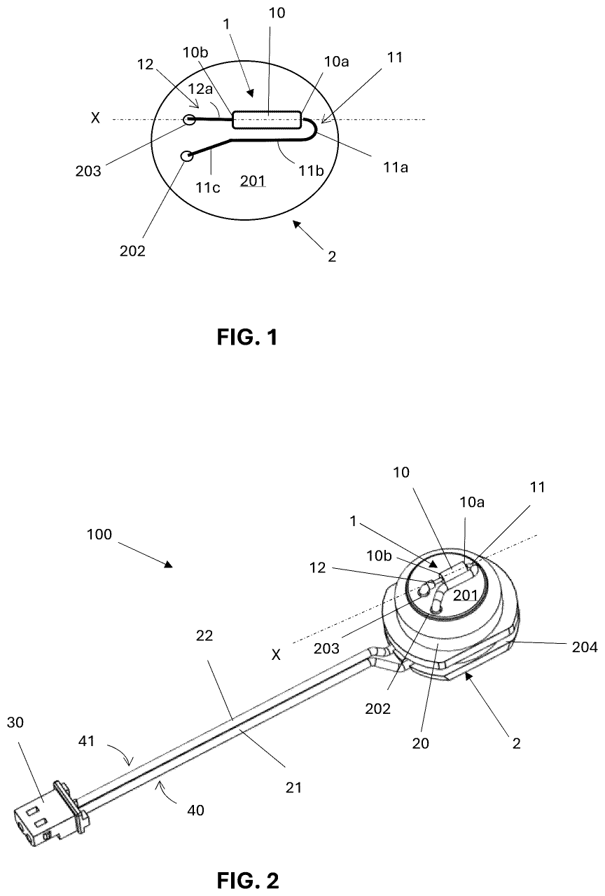

The temperature sensor assembly 100 of the invention comprises an axial thermistor 1 and a support 2 comprising a base 201 on which the thermistor 1 is arranged. As shown schematically in FIG. 1, the thermistor 1 comprises an elongate main body 10, a first pin 11 projecting axially from a first end 10a of the main body 10, and a second pin 12 projecting axially from a second end 10b of the main body 10. The main body 10 of the thermistor 1 arranged horizontally on the base 201.

The first pin 11 is connected to a first connecting cable 40 (not shown in FIG. 1) forming a first connecting segment, and the second pin 12 is connected to a second connecting cable 41 (not shown in FIG. 1) forming a second connecting segment. In the embodiment shown in FIGS. 2 to 4, both connecting segments are connected to a connector 30 via the respective connecting cable.

As shown in FIGS. 1, 2 and 3, the first pin 11 of the thermistor 1 comprises an initial bent segment 11a and an additional segment 11b following the initial segment which is arranged on the base 201 of the support 2 on one side of the main body 10 of the thermistor 1 and extends at least to the second end 10b of the main body 10 according to an axial direction X defined by the main body 10. In this way, the effect produced by the electromagnetic fields generated at the induction heater is minimised and the accuracy of the temperature measurement by the thermistor 1 is considerably improved.

In a preferred embodiment, as shown in the figures, the initial bent segment 11a of the first pin 11 of thermistor 1 is C-shaped.

In a preferred embodiment, as shown in the figures the additional segment 11b of the first pin 11 of the thermistor 1 is parallel to the main body 10. This causes the additional segment 11b to be arranged close to the main body 10, which helps to improve the accuracy of the temperature measurement.

In another preferred embodiment, not shown in the figures, the additional segment 11b of the first pin 11 of the thermistor 1 forms an angle of less than 45° with respect to the main body 10.

In a preferred embodiment, the second pin 12 of the thermistor 1 comprises a straight initial segment 12a.

As shown in the figures, in a preferred embodiment the first connecting segment (formed by the first pin 11 and the connecting cable to which it is connected) and the second connecting segment (formed by the second pin 12 and the connecting cable to which it is connected) pass through the base 201 of the support 2 through a respective first hole 202 and a second hole 203 arranged in the base 201.

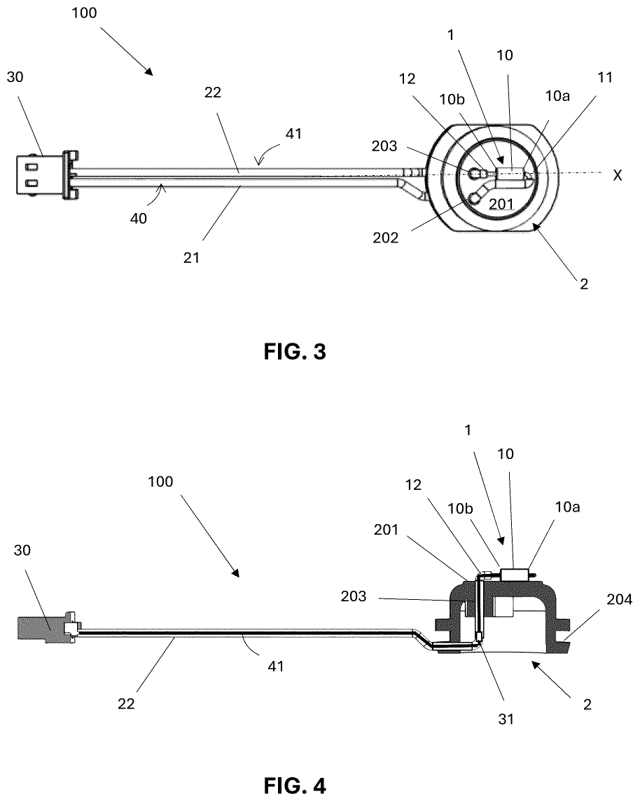

In a preferred embodiment, both holes 202 and 203 are arranged downstream of the second end 10b of the main body 10 along the axial direction X defined by the main body 10, as shown in FIGS. 1 and 3.

In a preferred embodiment, the additional segment 11b of the first pin 11 of the thermistor 1 is oriented towards the first hole 202 and said first pin 11 passes through the first hole 202. In the embodiment shown in the figures (see for example FIG. 1), the additional segment 11b of the first pin 11 of the thermistor 1 is parallel to the main body 10 of the thermistor 1 and the first pin 11 comprises an end segment 11c oriented towards the first hole 202 which passes through said hole 202 and which comprises an end connected to the first connecting cable 40. In an alternative embodiment, not shown in the figures, the additional segment 11b of the first pin 11 of the thermistor 1 is a straight segment oriented towards the hole 202 and which passes through the said hole 202, the additional segment comprising an end connected to the first connecting cable 40.

In a preferred embodiment, as shown in FIG. 4, the second pin 12 of the thermistor 1 is bent such that it passes through the base 201 of the support 2 through the second hole 203, the second pin 12 being connected to the respective connection cable below the base 201 of the support 2. The second pin 12 is connected to the connection cable via a junction 31.

In a preferred embodiment, as seen in FIGS. 1 and 3, the second hole 203 of the base 201 is axially aligned with the thermistor 1.

In a preferred embodiment, as shown in FIGS. 1 and 3, the first hole 202 and the second hole 203 are arranged side by side in the same axial position according to the axial direction X defined by the main body 10. Preferably the distance between the first hole 202 and the second hole 203 is smaller than the length of the main body 10 of the thermistor 1.

In a preferred embodiment, as shown in FIGS. 2 to 4, the first connecting cable 40 and at least part of the first pin 11 are covered by a first insulating sheath 21, and the second connecting cable 41 and at least part of the second pin 12 are covered by a second insulating sheath 22.

In a preferred embodiment, the support 2 is made of elastomeric material, preferably silicone. In a preferred embodiment the support 2 comprises a cylindrical body 20 projecting from the base 201 downwards, the cylindrical body 20 comprising at an end opposite the base 201 coupling means 204 for coupling the support 2 to an induction heater 200.

In a preferred embodiment, the thermistor 1 is a negative temperature coefficient (NTC) thermistor.

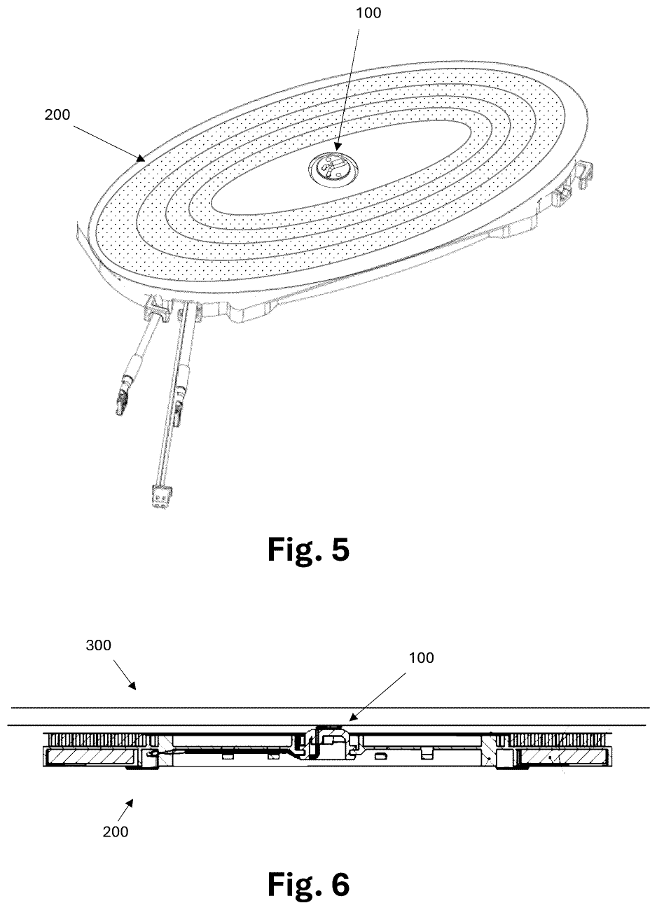

The invention also relates to an induction hob comprising a cooking plate 300, at least an induction heater 200 and a temperature sensor assembly 100 as described above associated with said induction heater 200. In a preferred embodiment, as shown in FIGS. 5 and 6, the temperature sensor assembly 100 is arranged coupled to the induction heater 200 in a central part of the induction heater 200. The thermistor 1 is preferably arranged in contact with the cooking plate 300.

1. A temperature sensor assembly for an induction hob, the temperature sensor assembly comprising;
a support having a base; and
a thermistor including an elongated main body having a horizontal axis and arranged horizontally on the base, the thermistor including a first pin projecting from a first end of the elongated main body and a second pin projecting from a second end of the elongated main body, the first pin being connected to a first connecting cable forming a first connecting segment, the second pin being connected to a second connecting cable forming a second connecting segment, the first pin including an initial bent segment and an additional segment following the initial bent segment, the additional segment being arranged on the base of the support on one side of the elongated main body and extending downstream along the base to a position at or beyond the second end of the elongated main body.

2. The temperature sensor assembly according to claim 1, wherein the first pin projects axially from the first end of the elongated main body and the second pin projects axially from a second end of the elongated main body.

3. The temperature sensor assembly according to claim 1, wherein the initial bent segment of the first pin of the thermistor is C-shaped.

4. The temperature sensor assembly according to claim 1, wherein the additional segment of the first pin is arranged parallel to the horizontal axis.

5. The temperature sensor assembly according to claim 3, wherein the additional segment of the first pin is arranged parallel to the horizontal axis.

6. The temperature sensor assembly according to claim 1, wherein the additional segment of the first pin is arranged an angle of less than 45° with respect to the horizontal axis.

7. The temperature sensor assembly according to claim 1, wherein the second pin comprises an initial straight segment.

8. The temperature sensor assembly according to claim 1, wherein the first and second connecting segments respectively pass through the base of the support through first and second holes in the base.

9. The temperature sensor assembly according to claim 8, wherein each of the first and second holes are located downstream of the second end of the elongated main body in a direction of the horizontal axis.

10. The temperature sensor assembly according to claim 9, wherein the additional segment of the first pin is oriented towards and passes through at least a portion of the first hole.

11. The temperature sensor assembly according to claim 8, wherein the first pin includes an end segment downstream the additional segment, the additional segment being parallel to the horizontal axis, the end segment being oriented towards the first hole and passing through at least a portion of the first hole.

12. The temperature sensor assembly according to claim 8, wherein the additional segment of the first pin is a straight segment oriented towards the first hole and passes through at least a portion of the first hole, the additional segment having an end connected to the first connecting cable.

13. The temperature sensor assembly according to claim 8, wherein the second pin is bent such that it passes through the base of the support through at least a portion of the second hole, the second pin being connected to the second connection cable under the base of the support.

14. The temperature sensor assembly according to claim 13, wherein the second pin is bent such that it passes through the base of the support through at least a portion of the second hole, the second pin being connected to the second connection cable under the base of the support.

15. The temperature sensor assembly according to claims 8, wherein the second hole is aligned with the horizontal axis.

16. The temperature sensor assembly according to claim 8, wherein the first hole and the second hole are arranged side by side along a line orthogonal to the horizontal axis.

17. The temperature sensor assembly according to claim 16, wherein a distance between the first and second holes is less than a length of the elongated main body.

18. The temperature sensor assembly according to claim 1, wherein the first connecting cable and at least part of the first pin are covered by a first insulating sheath, and the second connecting cable and at least part of the second pin are covered by a second insulating sheath.

19. An induction hob comprising a cooking plate, an induction heater located below the cooking plate, and a temperature sensor assembly according claim 1.

20. The induction hob according to claim 19, wherein the temperature sensor assembly is mechanically coupled to a central part of the induction heater.
